(19) United States
(12) Patent Application Publication
(10) Pub. No.: US 2023/0382489 A1
(43) Pub. Date: Nov. 30, 2023

(54) HYBRID DRIVE SYSTEM FOR A BICYCLE

(71) Applicant: Classified Cycling B.V., Antwerpen (BE)

(72) Inventor: Roëll Marie VAN DRUTEN, Eindhoven (NL)

(21) Appl. No.: 18/250,184

(22) PCT Filed: Apr. 28, 2022
(86) PCT No.: PCT/NL2021/050644

§ 371 Date: Apr. 22, 2023

(30) Foreign Application Priority Data
Oct. 23, 2020 (NL) 2026760
Nov. 13, 2020 (NL) 2026899
Mar. 4, 2021 (NL) 2027707

(51) Int. Cl. B62M 6/55; B62J 50/22; B62J 45/20; B62M 6/50; B62M 11/14; B62J 45/416; B62M 6/60

(52) U.S. Cl. CPC B62M 6/55; B62J 50/22; B62J 45/20; B62M 6/50; B62M 11/145; B62J 45/416; B62M 6/60

(57) ABSTRACT

The invention relates to a hybrid drive system for a bicycle comprising a crank, an electric motor, a rear wheel hub shell, an intermediate drive part, a first transmission connecting the crank to the intermediate drive part, and a second transmission connecting the electric motor to the intermediate drive part. The intermediate drive part is connected or connectable to the rear wheel hub shell. The system can include a first clutch between the intermediate drive part and the rear wheel hub shell for in a first mode rotationally coupling the rear wheel hub shell to the intermediate drive part, and in a second mode rotationally decoupling the rear wheel hub shell from the intermediate drive part.

### FIELD

The invention relates to a gear shifting mechanism for shifting gears on a bicycle. More in particular, the invention relates to a hybrid drive system for a bicycle, allowing both electric power and muscle power to be used for driving the bicycle.

### BACKGROUND

Bicycles driven by combined electric power from an electric motor and muscle power from a rider are generally known. These bicycles have a hybrid drive system allowing both electric power and muscle power to be used for driving the bicycle. The known hybrid bicycle drive systems normally are configured to either have a predetermined amount of electric torque transferred to the driven wheel hub, or to have the amount of electric torque transferred to the driven wheel hub be dependent on the amount of muscle power exerted by the rider.

A disadvantage of the known hybrid drive systems for a bicycle is that the functionality is limited.

### SUMMARY

It is an object to provide a hybrid drive system for a bicycle providing more functionality to the user.

Thereto, according to an aspect, is provided a hybrid drive system for a bicycle comprising a crank, an electric motor and a rear wheel hub shell. The electric motor can comprise a stator and a rotor. The stator can be positioned inside the rotor. The electric motor can be positioned inside the rear wheel hub shell. The hybrid drive system further comprises an intermediate drive part. The intermediate drive part can be positioned inside the rear wheel hub shell. The hybrid drive system comprises a first connection connecting the crank to the intermediate drive part. The first connection is configured for transmitting rotation, such as torque, from the crank to the intermediate drive part. The first connection can be a direct connection, directly coupling the crank, e.g. the crank shaft, to the intermediate drive part, or an indirect connection indirectly coupling the crank to the intermediate drive part. The first connection can be a first transmission, such as formed by a chain, belt and/or cardan drive. The crank can e.g. be connected to the intermediate drive part via a first freewheel clutch. The hybrid drive system comprises a second connection connecting the electric motor to the intermediate drive part. The second connection is configured for transmitting rotation, such as torque, from the electric motor to the intermediate drive part. The second connection can be a direct connection, directly coupling the electric motor to the intermediate drive part, or an indirect connection coupling the motor to the intermediate drive part via an intermediate structure. The second connection can include a second transmission. The second transmission can include a reduction gearing between the rotor of the electric motor and the intermediate drive part. The second transmission can be positioned inside the rear wheel hub shell. The intermediate drive part is connected or connectable to the rear wheel hub shell. Hence, the intermediate drive part can be connected to the rear wheel hub shell, e.g. for allowing the intermediate drive part to drive the rear wheel hub shell in rotation. The intermediate drive part can be released from the rear wheel hub shell, e.g. for allowing the intermediate drive part and the rear wheel hub shell to rotate or stand still independently of each other.

The electric motor can be positioned near the crank. The electric motor can e.g. be integrated with a crank shaft housing. The electric motor can be concentric with the crank shaft. The intermediate drive part can then also be positioned near the crank, such as integrated with the crank shaft housing. The intermediate drive part can e.g. be concentric with the crank shaft. If the first connection is a direct connection and the second connection is a direct connection, the intermediate drive part can be directly connected to the crank shaft and to the electric motor. The intermediate drive part be formed by the crank shaft. The first connection and the second connection can be one and the same. Then, the electric motor can be directly coupled to the crank shaft, the crank shaft or the electric motor being connected to the intermediate drive part via the first/second connection. The intermediate drive part can then be indirectly connectable to the rear wheel hub shell, e.g. via a chain, belt, cardan drive, or the like.

The electric motor can be positioned at the rear wheel hub shell. The electric motor can e.g. be positioned, at least partly, inside the rear wheel hub shell. The electric motor can be concentric with the rear wheel hub shell. The intermediate drive part can then also be positioned near the rear wheel hub shell, such as in the rear wheel hub shell. The intermediate drive part can e.g. be concentric with the rear wheel hub shell.

The hybrid drive system can comprises a first clutch between the intermediate drive part and the rear wheel hub shell for in a first mode rotationally coupling the rear wheel hub shell to the intermediate drive part, and in a second mode rotationally decoupling the rear wheel hub shell from the intermediate drive part. The first clutch can be positioned inside the rear wheel hub shell. Preferably, the first clutch is configured for in the second mode rotationally decoupling the rear wheel hub shell from the intermediate drive part in at least one rotation direction, preferably the forward drive rotation direction. The first clutch can be configured such that in the second mode no component that is driving the hub shell from the crank and/or the electric motor.

Hence, the crank and the electric motor both connect to the intermediate drive part to drive, or be driven by, the intermediate drive part in rotation. The first clutch in the first mode allows the rear wheel hub shell to be driven by, or drive, the intermediate drive part in rotation. The clutch in the second mode allows the rear wheel hub shell to remain still or rotate independent of rotation or standstill of the intermediate drive part, while the rear wheel hub remains attached to the frame of the bicycle.

Optionally, the first clutch is a form-closed clutch, such as a spline connection that can be decoupled, e.g. manually. The first clutch can be an active form-closed clutch, such as a clutch that can be decoupled by an actuator. The hybrid drive system can include an actuator for bringing the actuatable first clutch from the first mode to the second mode, and/or vice versa. The first clutch can be an active freewheel clutch which actively can be disengaged. The first clutch can be configured to be actively disengaged by an electric actuator. Hence, the active freewheel clutch can in the first mode allows the rear wheel hub shell to be driven by the intermediate drive part in forward rotation and freewheel in rearward rotation. The active freewheel clutch in the second mode allows the rear wheel hub shell to freewheel in forward rotation direction, e.g. in both forward and rearward rotation directions.

Optionally, the intermediate drive part is positioned inside the rear wheel drive hub shell. Optionally, the first clutch is positioned inside the rear wheel drive hub shell. Hence, a compact design is possible.

Optionally, the electric motor is configured to act as a generator when the first clutch is in the second mode. The electric motor can be configured to act as a generator for power coming from the crank. When the first clutch is in the second mode, the user pedaling to rotate the crank will not result in the rear wheel hub shell rotating as a result of the pedaling. Thus, the bicycle can be used stationary, e.g. on a mechanical stand, e.g. for training, such as in-door training. Special roller-type training devices or removal of the rear wheel is not required since the rear wheel hub shell can remain immobile due to the first clutch being in the second mode. The stand is arranged for keeping the bicycle in an upright position, and can include dampers sideways tilting of the bicycle to accommodate for sideway rider movements during pedaling. It will be appreciated that when the intermediate drive part is rigidly connected or to the rear wheel hub shell, or connected to the rear wheel hub shell by a freewheel clutch allowing the intermediate drive part to drive the rear wheel hub shell in rotation in the forward direction and to freewheel in the rearward direction, the bicycle can nevertheless be used on a roller-type training device.

The electric motor being configured to act as a generator allows for the pedaling to drive the generator, i.e. for the user to feel resistance during pedaling, so as to provide effective training. The resistance experienced during pedaling can be adjusted, by adjusting an electrical load resistance connected to the generator.

Optionally, the electric motor is configured to act as a generator when the first clutch is in the first mode. The electric motor can be configured to act as a generator for power coming from the crank and/or the wheel. When the first clutch is in the first mode, the user pedaling to rotate the crank will result in the rear wheel hub shell rotating as a result of the pedaling. Thus, the bicycle can be used for transportation and/or training, such as out-door training. The electric motor being configured to act as a generator allowing for the pedaling to drive both the rear wheel hub shell and the generator, i.e. for the user to feel additional resistance during pedaling, so as to provide effective training. The resistance due to the generator experienced during pedaling can be adjusted, by adjusting an electrical load resistance connected to the generator.

When the electric motor is configured to act as generator, the generated electric power can be used for charging a battery of the bicycle. When the first clutch is in the second mode, the generated electric power can also be used for charging a home battery, powering electrical appliances or transfer to an electricity grid.

Optionally, the electric motor is configured to act as a motor when the first clutch in the first mode. When the first clutch is in the first mode, the user pedaling to rotate the crank will result in the rear wheel hub shell rotating as a result of the pedaling. Thus, the bicycle can be used transportation and/or training. The electric motor being configured to act as a motor causes the bicycle to function as a bicycle with electric motor assistance.

Optionally, the hybrid drive system comprises an activator, such as a manual or electric activator, for switching the first clutch from the first mode top the second mode, or vice versa. The activator can e.g. be a mechanical switch, e.g. on the rear wheel hub. The activator can e.g. be a switch, e.g. on a handlebar of the bicycle for electrically actuating the first clutch.

Optionally, the hybrid drive system comprises a first freewheel clutch between the crank and the intermediate drive part. Alternatively, or additionally, the hybrid drive system comprises a first freewheel clutch between the intermediate drive part and the first clutch. Alternatively, or additionally, the hybrid drive system comprises a first freewheel clutch between the first clutch and the rear wheel hub shell. The first freewheel clutch can be a passive element, such as a freewheel clutch or freewheel bearing. The first freewheel clutch has an input and an output, and is configured to automatically engage when the speed of the input is higher than the speed of the output in a forward movement direction, and to disengages when the speed of the input is lower than the speed of the output in forward direction. Thus, when the first freewheel clutch is between the crank and the intermediate drive part the intermediate drive part can be driven in rotation in forward direction by the crank, but the crank will not be driven in rotation in forward direction by the intermediate drive part. When the first freewheel clutch is between the intermediate drive part and the first clutch the first clutch can be driven in rotation in forward direction by the intermediate drive part, but the intermediate drive part will not be driven in rotation in forward direction by the first clutch. When the first freewheel clutch is between the first clutch and the rear wheel hub shell the rear wheel hub shell can be driven in rotation in forward direction by the first clutch, but the first clutch will not be driven in rotation in forward direction by the rear wheel hub shell. Optionally the first freewheel clutch is positioned inside the rear wheel hub shell.

Optionally, the hybrid drive system comprises a third transmission between the intermediate drive part and the rear wheel hub shell. The third transmission can have a unity transmission ratio. Alternatively the third transmission can have a decreasing or increasing transmission ratio. The third transmission can have at least two selectable different transmission ratios. the third transmission can be configured to shift between the at least two transmission ratios under load. Optionally the third transmission is positioned inside the rear wheel hub shell. Optionally, the first clutch is part of the third transmission.

Optionally, the third transmission comprises a planetary gear set with at least three rotational members. The hybrid drive system can comprise a first second clutch configured for selectively connecting two of the at least three rotational members. The hybrid drive system can comprise a first second freewheel clutch between one of the rotational members and the first second clutch. Thus, the planetary gear set can selectively provide a first transmission ratio and a different second transmission ratio. The planetary gear set can be positioned inside the rear wheel hub shell. The first second clutch can be positioned inside the rear wheel hub shell.

Optionally, the hybrid drive comprises a third freewheel clutch between one of the rotation members of the third transmission and the stator of the electric motor. Optionally, the third freewheel clutch includes the first clutch. The third freewheel clutch can be positioned inside the rear wheel hub shell.

Optionally, the hybrid drive system comprises a fourth transmission between the crank and the intermediate drive part. The fourth transmission can e.g. be between the crank and the first freewheel clutch or between the first freewheel clutch and the intermediate drive part. The fourth transmission can have a unity transmission ratio. Alternatively the fourth transmission can have a decreasing or increasing transmission ratio. The fourth transmission can have at least two selectable different transmission ratios. the fourth transmission can be configured to shift between the at least two transmission ratios under load. Optionally the fourth transmission is positioned inside the rear wheel hub shell.

Optionally, the fourth transmission comprises a planetary gear set with at least three rotational members. The hybrid drive system can comprise a second second clutch configured for selectively connecting two of the at least three rotational members. The hybrid drive system can comprise a second second freewheel clutch between one of the rotational members and the second second clutch. Thus, the planetary gear set can selectively provide a first transmission ratio and a different second transmission ratio. The planetary gear set can be positioned inside the rear wheel hub shell. The second second clutch can be positioned inside the rear wheel hub shell.

Optionally, the hybrid drive comprises a fourth freewheel clutch between one of the rotation members of the fourth transmission and the stator of the electric motor. The fourth freewheel clutch can be positioned inside the rear wheel hub shell.

Optionally, the intermediate drive part is formed by, or rigidly connected to, a planet carrier of a planetary gear set of the second and/or third and/or fourth transmission.

Optionally, the crank is connected to the intermediate drive part via a ring gear of the planetary gear set of the second and/or third and/or fourth transmission.

Optionally, the electric motor is connected to the intermediate drive part via a sun gear of the planetary gear set of the second and/or third and/or fourth transmission.

Optionally, a rotor or stator of the electric motor is connected to the sun gear of the planetary gear set of the second and/or third and/or fourth transmission via a one-way clutch. Optionally, the hybrid drive system comprises a controller. The controller can be configured to control electric power provided to the electric motor. Alternatively, or additionally, the controller can be configured to control electric load resistance provided to the electric motor acting as generator.

Optionally, the controller is arranged to track a predetermined reference rotational speed of the crank over time and/or a predetermined reference ratio between the power output of the electric motor and the power output of the rider over time. Hence, a continuously variable transmission can be obtained.

Optionally, the hybrid drive system comprises a speed sensor configured for measuring a speed of the bicycle and/or a rotational speed of a wheel of the bicycle, the controller being operatively connected to the speed sensor. The controller may track a predetermined reference rotational speed of the crank over time and/or a predetermined reference ratio between the power output of the electric motor and the power output of the rider over time, based on a measurement of the speed of the bicycle and/or a rotational speed of a wheel of the bicycle.

Optionally, the hybrid drive system comprises a torque sensor between the crank and the intermediate drive part. The torque sensor can determine the torque exerted by muscle power by the rider. The torque sensor can e.g. be connected to the controller. The controller can control electric power provided to the electric motor, e.g. based on the torque determined by the torque sensor. Alternatively, the controller can control electric load resistance provided to the electric motor acting as generator, e.g. based on the torque determined by the torque sensor. The torque sensor can be positioned inside the rear wheel hub shell.

The torque sensor can combined with the first freewheel clutch. The torque sensor can e.g. be integrated in the first freewheel clutch. The torque sensor can combined with the first or the fourth transmission. The torque sensor can e.g. be integrated in the first or the fourth transmission. The torque sensor can be integrated in a crank arm. The torque sensor can be integrated in the crank shaft. The torque sensor can be positioned between the crank arm and the crank shaft. The torque sensor can be integrated in a front sprocket. The torque sensor can be positioned between the front sprocket and the crank arm or crank shaft.

Optionally, the third and/or fourth transmission comprises a planetary gear set with at least three rotational members.

Optionally, the controller includes or is communicatively connectable to bicycle computer. The bicycle computer can include a user interface. The bicycle computer and/or the user interface can e.g. be formed by an app executed on a mobile communications device, such as a smartphone, communicatively connected to the controller, e.g. via wifi, bluetooth, nfc or the like. The user interface can include an input, such as a touch screen and/or buttons, and an output, such as a screen. The user interface can e.g. include a touch screen.

The user interface can be configured for allowing a user to select operation of the first clutch. The user interface can e.g. include a control element, such as a switch, for switching the first clutch from the first mode to the second mode, or vice versa.

The user interface can be configured for allowing the user to control operation of the electric motor. The user interface can e.g. include a control element, such as a switch, for switching the electric motor to act as motor or to act as generator. The user interface can e.g. include a control element for setting a parameter representative of a value of an electric load resistance connected to the electric generator.

The user interface can be configured for setting a training program. The training program can include a variable electric load resistance of the generator, e.g. varying in time. The training program can include a simulation of a terrain. The simulation can include a variable electric load resistance of the generator corresponding to an inclination of the simulated terrain. The bicycle computer can be configured to be programmed by the user to follow a certain load profile and to control the electric motor accordingly in riding mode (first clutch in the first mode) and in training mode (first clutch in the second mode)

When the first clutch is in the second mode, the variable electric load resistance of the generator can directly correspond to an inclination of the simulated terrain. When the first clutch is in the first mode, the variable electric load resistance of the generator can be calculated on the basis of a desired inclination of the simulated terrain, and on the basis of a torque exerted by the rider, e.g. as measured by the torque sensor. Hence, the rider can experience a training session providing resistance as if he is riding in mountainous terrain while actually riding on a level road.

The hybrid drive system can include a heart rate sensor to measure a heart rate of the rider. The bicycle computer can be configured to adjust the electric load resistance of the generator on the basis of a measured heart rate of the rider. The electric load resistance can e.g. be adjusted such that the measured heart rate of the rider corresponds to a predetermined heart rate, or follows a predetermined heart rate profile in time, such as during training.

The hybrid drive system can include a pedaling rate sensor to measure a pedaling rate of the rider. The bicycle computer can be configured to adjust an electric load resistance of the generator, an electric power provided to the electric motor, and/or a transmission ratio of one or more of the first, second, third and fourth transmissions, on the basis of a measured pedaling rate of the rider. The electric load resistance of the generator, electric power provided to the electric motor, and/or transmission ratio of one or more of the first, second, third and fourth transmissions can e.g. be adjusted such that the measured pedaling rate of the rider corresponds to a predetermined pedaling rate, or follows a predetermined pedaling rate profile in time, such as during training.

Optionally, one or more of the first, second, third and fourth transmissions is a continuously variable transmission. The bicycle computer can be configured to adjust the continuously variable transmission such that the measured pedaling rate of the rider corresponds to a predetermined pedaling rate, or follows a predetermined pedaling rate profile in time, such as during training.

The hybrid drive system can be configured to determine a pedaling power of the rider. The pedaling power can e.g. be determined based on the torque sensor. The hybrid drive system can include a pedaling power sensor. The bicycle computer can be configured to adjust an electric load resistance of the generator, an electric power provided to the electric motor, and/or a transmission ratio of one or more of the first, second, third and fourth transmissions, on the basis of a determined pedaling power of the rider. The electric load resistance of the generator, electric power provided to the electric motor, and/or transmission ratio of one or more of the first, second, third and fourth transmissions can e.g. be adjusted such that the measured pedaling power of the rider corresponds to a predetermined pedaling power, or follows a predetermined pedaling power profile in time, such as during training.

Optionally, the electric motor, the intermediate drive part, the first clutch and the second transmission are positioned inside the rear wheel hub shell. Optionally, one or more of the first freewheel clutch, the third transmission and the fourth transmission are also positioned inside the rear wheel hub shell.

According to an aspect is provided a rear wheel hub assembly for a bicycle. The rear wheel hub assembly includes a driver connectable to a crank of the bicycle. The driver can e.g. be configured to receive a cassette including a plurality of sprockets, or a plurality of sprockets, e.g. for a chain or belt drive. The driver can be configured to attach a belt pulley thereto, e.g. for a belt drive. The driver can be configured to attach a (bevel) gear thereto, e.g. for a cardan drive. The rear wheel hub assembly includes an electric motor. The rear wheel hub assembly includes an intermediate drive part rotationally coupled to the driver, e.g. via a first freewheel clutch, and rotationally coupled to a rotor of the electric motor. The rear wheel hub assembly includes a rear wheel hub shell. The intermediate drive part is connected or connectable to the rear wheel hub shell. The rear wheel hub assembly can include a second transmission. The intermediate drive part can be rotationally coupled to the rotor of the electric motor via the second transmission.

Optionally, the rear wheel hub assembly further includes a first clutch between the intermediate drive part and a rear wheel hub shell for in a first mode rotationally coupling the rear wheel hub shell to the intermediate drive part, and in a second mode rotationally decoupling the rear wheel hub shell from the intermediate drive part.

The first clutch can be a form-closed clutch. The first clutch can be an active form-closed clutch. The first clutch can be an active freewheel clutch configured to be actively disengaged.

Optionally, the electric motor, the intermediate drive part, the first clutch and the second transmission are positioned inside the rear wheel hub shell of the rear wheel hub assembly. Optionally, one or more of the first freewheel clutch, the third transmission and the fourth transmission are also positioned inside the rear wheel hub shell of the rear wheel hub assembly.

Optionally, the intermediate drive part is positioned, at least partially, radially inside the sprocket, the plurality of sprockets, the cassette, the belt pulley or the (bevel) gear. Optionally, the intermediate drive part is positioned radially inside at least one sprocket of the one or more sprockets. The sprocket, the plurality of sprockets, the cassette, the belt pulley or the (bevel) gear can have a tapered central axial opening. The tapered central axial opening can have an internal diameter decreasing in a direction away from a center of the rear wheel hub assembly The tapered central axial opening can have a larger diameter at larger sprockets and a smaller diameter at smaller sprockets. The sprockets of the plurality of sprockets can each have a central opening, wherein the central opening of larger sprockets is larger than the central opening of smaller sprockets. Optionally, the sprocket, the plurality of sprockets, the cassette, the belt pulley or the (bevel) gear and the driver are configured to transmit torque from the sprocket, the plurality of sprockets, the cassette, the belt pulley or the (bevel) gear to the driver at portion of the sprocket, the plurality of sprockets, the cassette, the belt pulley or the (bevel) gear axially away from the center of the wheel hub assembly (e.g. away from a largest sprocket of the cassette in a direction of a smallest sprocket of the cassette). Optionally, the cassette and driver are configured to transmit torque from the cassette to the driver at portion of the cassette at or near the smallest sprocket of the cassette. Optionally, the one or more sprockets or the cassette and driver are configured to transmit torque from the one or more sprockets or the cassette to the driver at portion of the one or more sprockets or the cassette at or near the smallest sprocket of the one or more sprockets or the cassette. Optionally, the sprocket or the plurality of sprockets or the cassette transmits torque to the driver on a diameter that is smaller than a diameter of a smallest sprocket, of the plurality of sprockets or the cassette. Optionally, the sprocket, the plurality of sprockets, the cassette, the belt pulley or the (bevel) gear transmits torque to the driver on a smallest diameter. Optionally, the sprocket, the plurality of sprockets, the cassette, the belt pulley or the (bevel) gear transmits torque to the driver on a diameter that is smaller than or equal to a smallest inner diameter of the sprocket, the plurality of sprockets, the cassette, the belt pulley or the (bevel) gear. Optionally, the driver is configured to transmit torque to the intermediate drive part on a diameter that is smaller than a diameter of a smallest sprocket connected to the driver.

Optionally, the sprocket, the plurality of sprockets, the cassette, the belt pulley or the (bevel) gear which are connected to the driver are supported on the wheel hub directly via a bearing. The rear wheel hub assembly can include an axle, such as a hollow axle, around which the hub shell revolves. The axle can be configured to be immobile relative to a frame of the bicycle. The stator of the electric motor can be rigidly connected to the axle. Optionally, the wheel hub is supported on the driver side of the wheel axle assembly via a bearing, which bearing is positioned axially further from a center of the wheel axle assembly than a middle sprocket.

Optionally, the rear wheel hub assembly also includes one or more of the third and fourth transmission as described above.

Optionally, the rear wheel hub assembly further includes one or more of the torque sensor, the second clutch, end second freewheel clutch.

Optionally the rear wheel hub shell is configured to be decoupled from the driver.

According to an aspect is provided a crank axle assembly for a bicycle, comprising a crank shaft and an electric motor. The crank axle assembly comprises an intermediate drive part rotationally coupled to the crank shaft and rotationally coupled to a rotor of the electric motor. The intermediate drive part is connected or connectable to a rear wheel hub shell.

Optionally, the rotor of the electric motor is concentric with the crank shaft.

Optionally, the crank axle assembly includes a second transmission, wherein the intermediate drive part is rotationally coupled to the rotor of the electric motor via the second transmission.

Optionally, the crank axle assembly comprises a first clutch between the intermediate drive part and the rear wheel hub shell for in a first mode rotationally coupling the rear wheel hub shell to the intermediate drive part, and in a second mode rotationally decoupling the rear wheel hub shell from the intermediate drive part in at least one rotation direction.

Optionally, the first clutch is a form-closed clutch, an active form-closed clutch, or an active freewheel clutch configured to be actively disengaged.

According to an aspect is provided a rear wheel including the rear wheel hub assembly.

According to an aspect is provided a bicycle including the rear wheel and/or the crank axle assembly.

According to an aspect is provided a method for riding a bicycle, including providing input torque to a crank, transferring the input torque to an intermediate drive part, transferring a first part of the input torque from the intermediate drive part to a rear wheel for propelling the bicycle, and transferring a second part of the input torque from the intermediate drive part to an electric generator connected to an electric load resistance. The value of the electric load resistance can be varied as described above.

It will be appreciated that all features and options mentioned in view of the hybrid drive system apply equally to the rear wheel hub assembly, the crank axle assembly, the rear wheel, the bicycle and the method, and vice versa. It will also be clear that any one or more of the above aspects, features and options can be combined.

### BRIEF DESCRIPTION OF THE DRAWINGS

Embodiments of the present invention will now be described in detail with reference to the accompanying drawings in which:

FIG. 1 shows a schematic representation of a hybrid drive system;

FIG. 2A shows a schematic representation of a hybrid drive system;

FIG. 2B shows a schematic representation of a hybrid drive system;

FIG. 3 shows a schematic representation of a hybrid drive system;

FIG. 4 shows a schematic representation of an example of a cross sectional view of a wheel hub assembly;

FIG. 5A shows a schematic representation of an example of a cross sectional view of a wheel hub assembly;

FIG. 5B shows a schematic representation of an example of a cross sectional view of a wheel hub assembly;

FIG. 6 shows a schematic representation of a hybrid drive system;

FIG. 7 shows a schematic representation of a hybrid drive system;

FIG. 8 shows a schematic representation of an example of a cross sectional view of a wheel hub assembly; and

FIG. 9 shows a schematic representation of an example of a cross sectional view of a wheel hub assembly.

### DETAILED DESCRIPTION

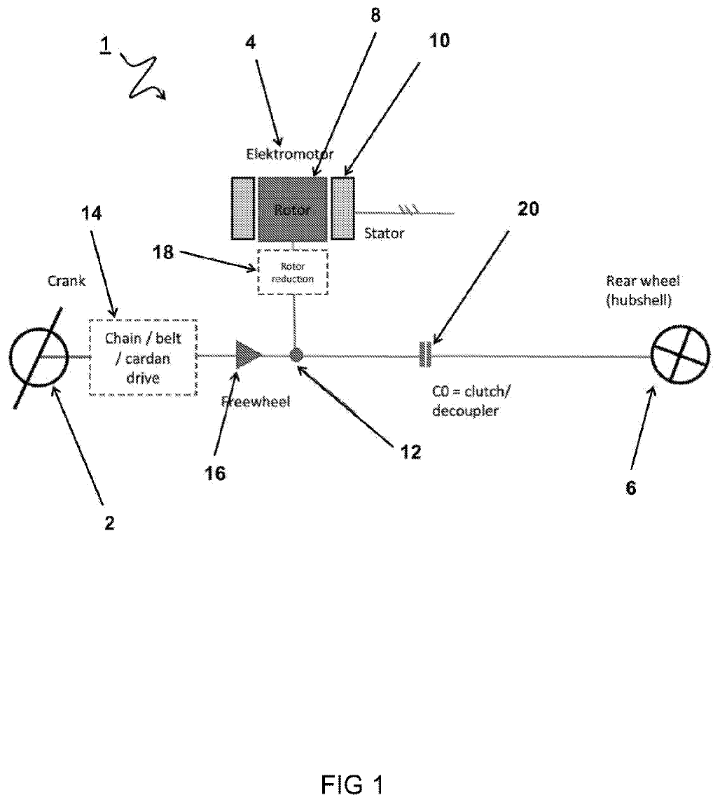

FIG. 1 shows a schematic representation of an example of a hybrid drive system 1 for a bicycle. The drive system 1 comprises a crank 2, an electric motor 4 and a rear wheel hub shell 6. The electric motor 4 includes a stator 8 and a rotor 10. In this example, the stator 8 is drawn as surrounding the rotor 10. It is also possible that the stator 8 is positioned inside the rotor 10. The drive system 1 further comprises an intermediate drive part 12. The drive system 1 in this example comprises a first transmission 14, such as formed by a chain, belt and/or cardan drive. The first transmission 14 connects the crank 2 to the intermediate drive part 12. Here, the crank is connected to the intermediate drive part 12 via a first freewheel clutch 16. In this example, the electric motor 4 is positioned at the rear wheel. The electric motor 4 can e.g. be integrated in the rear wheel hub shell 6. It will be appreciated that it is also possible that the electric motor 4 is positioned near the crank 2. The electric motor 4 can e.g. be mounted to or integrated in a crank axle assembly. When the electric motor 4 is positioned at the crank, the first transmission may be omitted, i.e. replaced by a direct connection or a transmission having a unity transmission ratio.

The drive system 1 in this example comprises a second transmission 18 connecting the electric motor 4 to the intermediate drive part 12. The second transmission 18 in this example includes a reduction gearing between the rotor 8 of the electric motor 4 and the intermediate drive part 12. Embodiments are also envisaged in which the second transmission is omitted, i.e. replaced by a direct connection or a transmission having a unity transmission ratio. The drive system 1 comprises a first clutch 20 between the intermediate drive part 12 and the rear wheel hub shell 6. The first clutch 20 can selectively be in a first mode or in a second mode. In the first mode the first clutch 20 rotationally couples the rear wheel hub shell 6 to the intermediate drive part 12. Thus, when the first clutch 20 is in the first mode, driving the intermediate drive part 12 in rotation, e.g. by the crank 2 and/or the electric motor 4, will drive the rear wheel hub shell 6 in rotation. In the second mode the first clutch 20 rotationally decoupling the rear wheel hub shell 6 from the intermediate drive part 12. Thus, when the first clutch 20 is in the second mode, driving the intermediate drive part 12 in rotation, e.g. by the crank 2 and/or the electric motor 4, will not drive the rear wheel hub shell 6 in rotation. When the first clutch 20 is in the second mode, the rear wheel hub shell 6 can remain still notwithstanding rotation of the crank 2 and the electric motor 4.

The rotor 8 of the electric motor 4 can provide torque to the intermediate drive part 12, e.g. in addition to muscle power provided to the crank 2. Hence, the electric motor 4 can act as a motor. When the first clutch 20 is in the first mode, the user pedaling to rotate the crank 2 will result in the rear wheel hub shell 6 rotating as a result of the pedaling. Thus, the bicycle can be used transportation and/or training. The electric motor 4 being configured to act as a motor causes the bicycle to function as a bicycle with electric motor assistance.

Alternatively, the rotor 8 of the electric motor 4 can brake rotation of the crank 2 when the crank 2 is being used as input of muscle power. Hence, the electric motor 4 can act as a generator and generate energy. The energy can e.g. be used for charging a battery of the bicycle. The rotor 8 of the electric motor can provide mechanical resistance to rotating the crank 2, such as by pedaling. An amount of mechanical resistance provided by the rotor can be controlled by controlling an amount of electric load resistance connected to electric terminals of the electric motor 4.

When the first clutch 20 is in the second mode, the rotor 8 of the electric motor can provide mechanical resistance to rotating the crank 2, such as by pedaling, without driving the rear wheel hub shell in rotation. Thus, the bicycle can be used for training, e.g. in-door, without a need for using an external roller as the rear wheel of the bicycle (and the front wheel) is not rotating. The electric motor 4 acting as a generator allows for the pedaling to drive the generator, i.e. for the user to feel resistance during pedaling, so as to provide effective training.

When the first clutch 20 is in the first mode, the rotor 8 of the electric motor can provide mechanical resistance to rotating the crank 2, such as by pedaling, while driving the rear wheel hub shell in rotation. Thus, the bicycle can be used for training, e.g. out-door, while providing extra resistance. The electric motor 4 acting as a generator allows for the pedaling to drive the generator, i.e. for the user to feel resistance during pedaling, so as to provide effective training.

The first freewheel clutch 16 in this example has an input connected to the crank 2, e.g. via the first transmission 14, and an output connected to the intermediate drive part 12. The first freewheel clutch 16 is configured to automatically engage, i.e. rotationally couple its input to its output, when the rotational speed of the input is higher than the rotational speed of the output in a forward movement direction of the bicycle. The first freewheel clutch 16 is configured to disengage, i.e. rotationally decouple its input from its output, when the rotational speed of the input is lower than the rotational speed of the output in the forward movement direction of the bicycle. Thus, the intermediate drive part 12 can be driven in rotation in forward direction by the crank 2, but the crank 2 will not be driven in rotation in forward direction by the intermediate drive part 12. Hence, rotation of the crank 2 can be stopped without feeling the inertia of the rotor 8.

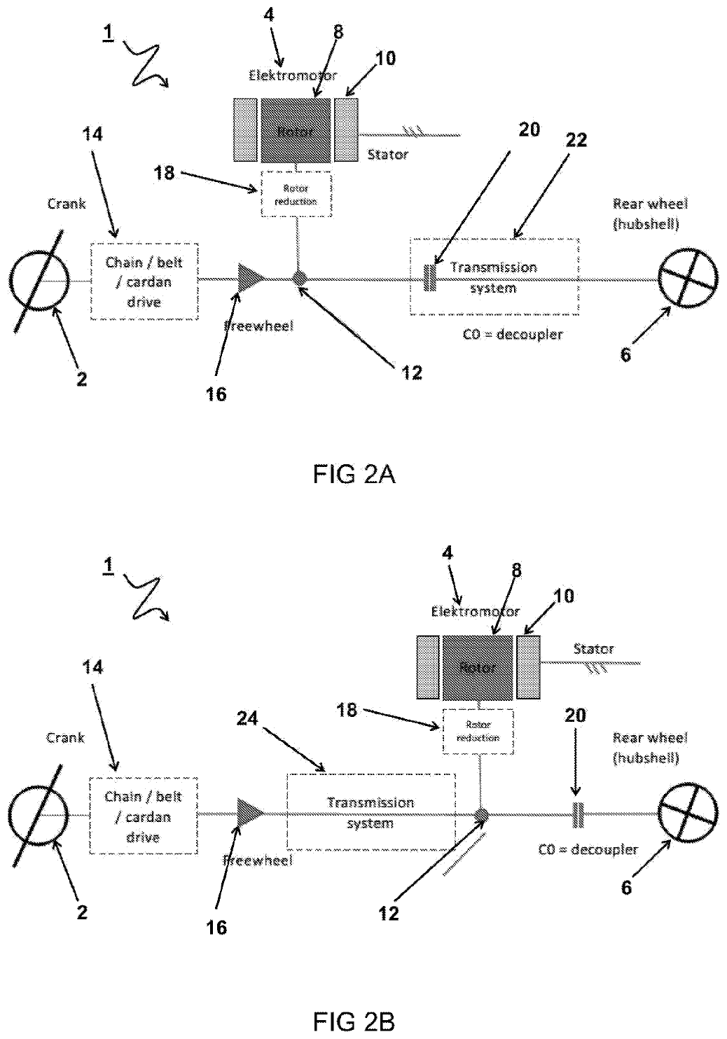

FIG. 2A shows a schematic representation of an example of a hybrid drive system 1 for a bicycle. The system 1 of FIG. 2A is similar to the system 1 of FIG. 1. In this example, the drive system 1 comprises a third transmission 22 between the intermediate drive part 12 and the rear wheel hub shell 6. Here, the third transmission 22 includes at least two selectable different transmission ratios. Here, the third transmission 22 is configured to shift between the at least two transmission ratios under load. In this example one of the at least two selectable transmissions has a unity transmission ratio. The other one or more transmission ratios can be decreasing and/or increasing transmission ratios.

FIG. 2B shows a schematic representation of an example of a hybrid drive system 1 for a bicycle. The system 1 of FIG. 2B is similar to the system 1 of FIG. 1. In this example, the drive system 1 comprises a fourth transmission 24 between the crank 2 and the intermediate drive part 12. Here the fourth transmission 24 connects the first transmission 14 to the intermediate drive par 12. Here, the fourth transmission 24 includes at least two selectable different transmission ratios. Here, the fourth transmission 24 is configured to shift between the at least two transmission ratios under load. In this example one of the at least two selectable transmissions has a unity transmission ratio. The other one or more transmission ratios can be decreasing and/or increasing transmission ratios.

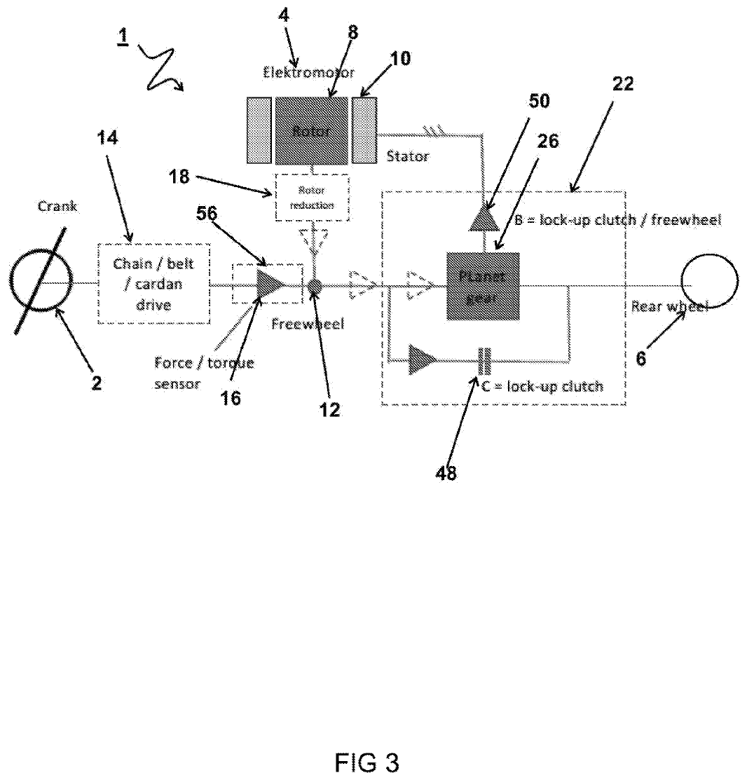

FIG. 3 shows a schematic representation of an example of a hybrid drive system 1 for a bicycle. The system 1 of FIG. 3 is similar to the system 1 of FIG. 2A. In this example, the intermediate drive part 12 drives the hub shell 6 via the third transmission 22 and the first clutch 20. In this example, the third transmission 22 comprises a planetary gear set 26. The planetary gear set includes at least three rotational members. The at least three rotational members here include a sun gear 26S, a planet carrier 26C with one or more planet gears 26P and a ring gear 26R. The third transmission further includes a second clutch 48 and a second freewheel clutch 50. For example, the intermediate drive part 12 is rigidly connected to the ring gear 26R. The sun gear 26S is connected to the axle 36 as explained below. In this example, the third transmission 22 includes two selectable transmission ratios. For switching between the two ratios the third transmission 22 includes a second clutch 48. In a first transmission mode, the second clutch 48 rotationally couples the planet carrier 26C to corotate with the ring gear 26R. Hence, a unity transmission ratio is provided. The sun gear 26S is allowed to rotate in a forward drive direction relative to the axle 36 because of a second freewheel clutch 50 between the sun gear 26S and the axle 36. In a second transmission mode, the second clutch 48 decouples the planet carrier 26C from the ring gear 26R. Hence, the planet carrier 26C can rotate independently from the ring gear 26R. The second freewheel clutch 50 prevents the sun gear 26S from rotating in a rearward drive direction relative to the axle 36. Hence, a reducing transmission ratio is provided.

In this example, the first clutch 20 is integrated into the second freewheel clutch 50. Here, the in the first mode the second freewheel clutch works as described above. I.e. the second freewheel clutch 50 allows the sun gear 26S to rotate in a forward drive direction, and prevents the sun gear 26S to rotate in a rearward drive direction. In the second node, the second freewheel clutch 50 allows the sun gear to rotate in the rearward drive direction. Hence, the ring gear 26R will drive the sung gear 26S via the planet gears 26P. As the sun gear is free to rotate in the rearward drive direction, the planet carrier 26C will not be rotated and the wheel hub shell 6 will not be driven in rotation by the third transmission 22.

As shown in FIG. 3 there can a further freewheel clutch in series with the second clutch 48. Further, as shown in FIG. 3, there can be one or more optional freewheel clutches (indicated as dashed triangles) at various locations in the hybrid drive system 1. These optional freewheel clutches can be additional to the first or second freewheel clutch or replace the first or second freewheel clutch.

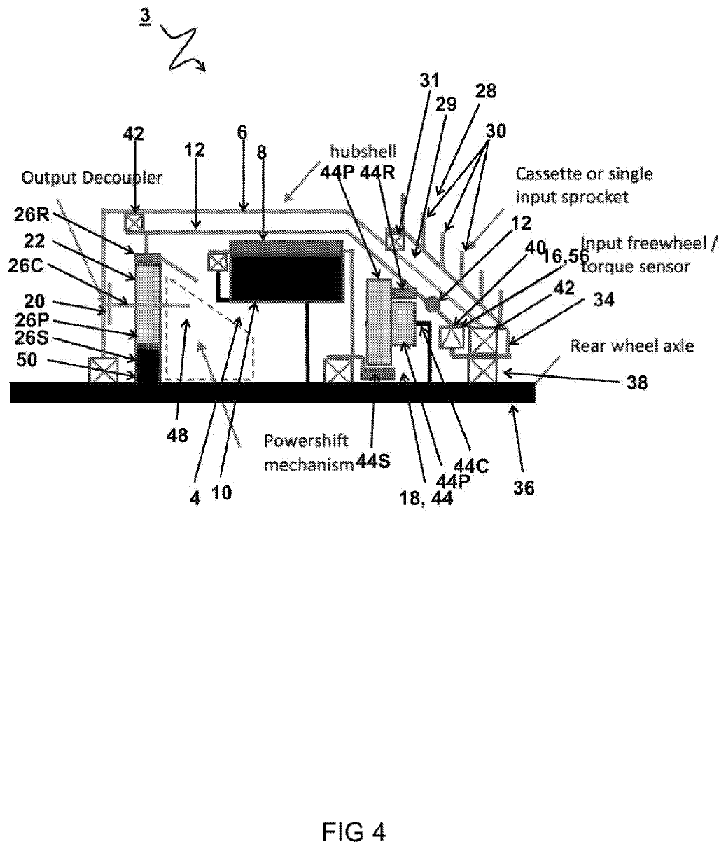

FIG. 4 shows a schematic representation of an example of a cross sectional view of a wheel hub assembly 3. The wheel hub assembly 3 can be part of the hybrid drive system 1. FIG. 4 shows a cassette 28 comprising one or more input sprocket 30. The cassette 28 or input sprockets 30 can be part of the first transmission 14. The sprockets 30 can e.g. be driven by a chain (not shown), in turn driven by a front sprocket attached to the crank 2. The cassette is mounted to a driver 34 which is rotatable mounted onto an axle 36, e.g. via a bearing 38. The driver 34 is coupled to the intermediate drive part 12 via the first freewheel clutch 16. In this example, the intermediate drive part 12 forms an inner shell, rotatably housed inside the hub shell 6. Here, the hub shell 6 is rotatable mounted to an outer side of the intermediate drive part 12 via bearings 42. It will be appreciated that instead of a cassette 28 it is also possible that a single sprocket 30 is attached to the driver 34, or a plurality of sprockets 30, or a belt pulley, or a (bevel gear).

Here, the cassette 28 has a tapered central axial opening 29. The tapered central axial opening 9 has a larger diameter at larger sprockets and a smaller diameter at smaller sprockets. Here, the wheel hub shell 6 extends into the tapered central axial opening 29. Hence, the wheel hub shell 6 is positioned, at least partially, radially inside the cassette 28. In this example, also the intermediate drive part 12 is positioned, at least partially, radially inside the cassette 28. The cassette 28 is supported on the wheel hub shell 6 via a bearing 31. It will be appreciated that in this example, the cassette 28 transfers torque to the driver 34 at a distal end of the cassette 28, axially away from a center of the wheel hub assembly 3. Thus, the cassette 28 transmits torque to the driver 34 on a diameter that is smaller than a diameter of a smallest sprocket 30 of the cassette 28. Here, the cassette 28 transmits torque to the driver 34 on a diameter that is smaller than or equal to an inner diameter of the smallest sprocket of the cassette. Also in this example, the driver 34 transmits torque to the intermediate drive part 12 on a diameter that is smaller than or equal to an inner diameter of the smallest sprocket 30 of the cassette 28. It will be clear that the tapered central opening 29 can also be provided in the single sprocket the plurality of sprockets 30, the belt pulley or the (bevel) gear, in case these are attached to the driver 34. What is explained in view of the cassette 28 in view of FIG. 4, especially in view of the central opening 29 and its relation to the intermediate drive part 12 and the wheel hub shell 6, applies similarly to the single sprocket, the plurality of sprockets, the belt pulley or the (bevel) gear.

FIG. 4 further shows the electric motor 4. In this example the stator 10 is positioned concentrically inside the rotor 8 of the electric motor 4. The stator 10 is rigidly connected to the axle 36. The axle 36 is configured to be attached to a frame of the bicycle, such that the axle 36 does not rotate relative to the frame. Hence, the stator 10 is immobile relative to the frame. The rotor 8 is connected to the intermediate drive part 12 via the second transmission 18. In this example, the second transmission is a planetary gear set 44. Here, the rotor 8 drives the sun gear 44S of the planetary gear set 44. The planet carrier 44C is rigidly connected to the axle 36. In this example, the planet carrier 44C carries planet gears 44P of two sizes. The ring gear 44R is rigidly coupled to the intermediate drive part 12. Hence, the planetary gear set 44 forms a reducing transmission ratio from the rotor 8 to the intermediate drive part 12.

In FIG. 4 the intermediate drive part 12 drives the hub shell 6 via the third transmission 22 and the first clutch 20. The third transmission 22 in this example includes a planetary gear set 26. Here, the intermediate drive part 12 is rigidly connected to the ring gear 26R. The planet carrier 26C is rigidly connected to an input of the first clutch 20. The sun gear 26S is connected to the axle 36 as explained below. In this example, the third transmission 22 includes two selectable transmission ratios. For switching between the two ratios the third transmission 22 includes a second clutch 48. In a first mode, the second clutch 48 rotationally couples the planet carrier 26C to corotate with the ring gear 26R. Hence, a unity transmission ratio is provided. The sun gear 26S is allowed to rotate in a forward drive direction relative to the axle 36 because of a second freewheel clutch 50 between the sun gear 26S and the axle 36. In a second mode, the second clutch 48 decouples the planet carrier 26C from the ring gear 26R. Hence, the planet carrier 26C can rotate independently from the ring gear 26R. The second freewheel clutch 50 prevents the sun gear 26S from rotating in a rearward drive direction relative to the axle 36. Hence, a reducing transmission ratio is provided.

In this example, the first clutch 20 selectively can be in a first mode or in a second mode. In the first mode the first clutch 20 couples the hub shell 6 to the third transmission 22, to be driven in rotation by the third transmission 22. In the second mode, the first clutch 20 decouples the hub shell 6 from the third transmission 22, so that the hub shell can rotate or stand still independently of rotation of the third transmission 22.

It will be appreciated that the hub shell 6 can include spokes flanges 52 for connecting spokes of a bicycle wheel thereto.

In the example of FIG. 4, the electric motor 4, the intermediate drive part 12, the first clutch 20 and the second transmission 18 are positioned inside the rear wheel hub shell 6. Further, in the example of FIG. 4, the first freewheel clutch 16 is also positioned inside the rear wheel hub shell 6. In the example of FIG. 4, further the third transmission 22, the second clutch 48 and the second freewheel clutch 50 are positioned inside the rear wheel hub shell 6.

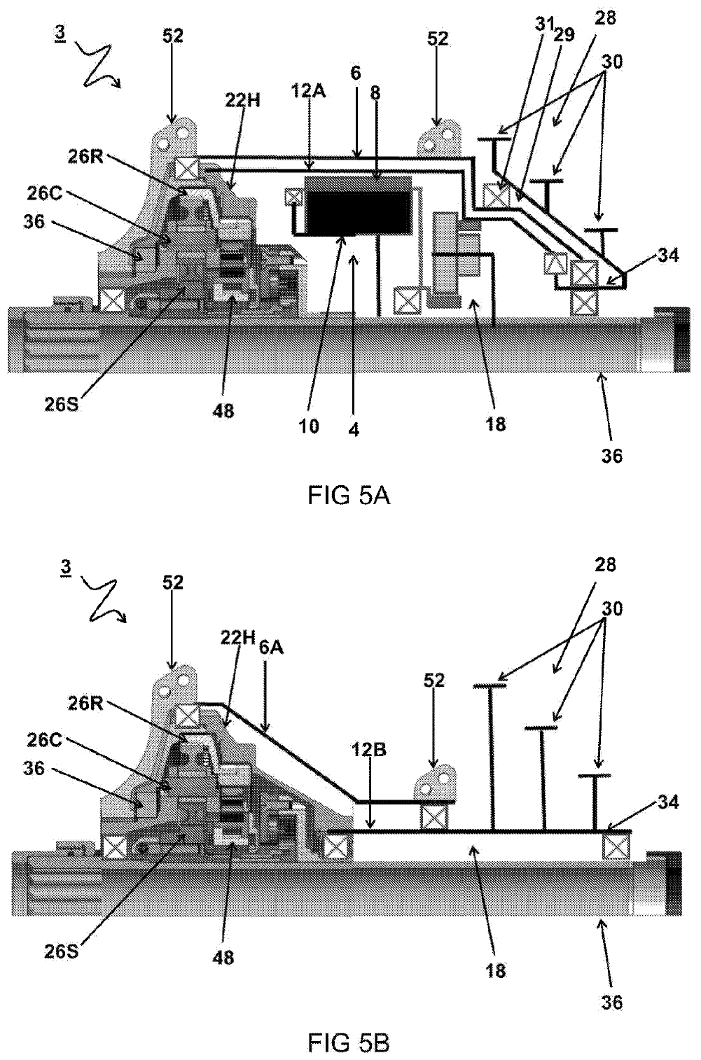

FIG. 5A shows a schematic representation of an example of a cross sectional view of a wheel hub assembly 3. The example of FIG. 5A is similar to the example of FIG. 4. In the example of FIG. 5A the wheel hub assembly 3 includes the electric motor 4. The electric motor 4 is positioned inside the wheel hub shell 6. Here, the intermediate drive part 12 comprises an inner shell 12A inside the hub shell 6. The inner shell can rotate independent of the hub shell 6 when the first clutch 20 is in the second mode as described above. In this example, the wheel hub assembly comprises a transmission housing 22H housing the third transmission. The inner shell 12A is configured to be releasably connected to the transmission housing 22H, e.g. by a suitable threaded connection.

FIG. 5B shows a schematic representation of an example of a cross sectional view of a wheel hub assembly 3. In this example, the wheel hub assembly 3 does not include an electric motor. In this example, the inner shell 12B has a smaller inner diameter no electric motor needs to be accommodated inside the inner shell 12B. As a result the wheel hub shell 6 can also be provided, at least partially, with a smaller inner diameter. Here the wheel hub shell 6 is also provided partially with a smaller outer diameter. It is possible that the wheel hub assembly 3 can be arranged such that it can, at will, be used with either the electric motor 4, the intermediate drive part 12A and the hub shell 6 of FIG. 5A, or without the electric motor and with the intermediate drive part 12B and the hub shell 6A of FIG. 5B. The intermediate drive part 12B and the hub shell 6A can e.g. be provided as kit for retrofitting on the hub shell assembly 3 of FIG. 5A. The electric motor 4, the intermediate drive part 12A and the hub shell 6 can e.g. be provided as kit for retrofitting on the hub shell assembly 3 of FIG. 5B. The hub shell assembly 3 can include both the intermediate drive parts 12A and 12B and both the hub shells 6 and 6A, so the user can select the desired parts to be mounted.

The hybrid drive system 1 and wheel hub assembly 3 as described thus far can be used as follows.

In a first use case, the electric motor 4 can configured to act as a generator when the first clutch 20 is in the second mode. When the first clutch 20 is in the second mode, the user pedaling to rotate the crank 2 will not result in the rear wheel hub shell 6 rotating as a result of the pedaling. Thus, the bicycle can be used stationary, e.g. on a mechanical stand (not shown), e.g. for training, such as in-door training. The stand can be arranged for keeping the bicycle in an upright position, and can include dampers sideways tilting of the bicycle to accommodate for sideway rider movements during pedaling. The electric motor 4 being configured to act as a generator allows for the pedaling to drive the generator, i.e. for the user to feel resistance during pedaling, so as to provide effective training. The resistance experienced during pedaling can be adjusted, by adjusting an electrical load resistance connected to the generator.

In a second use case, the electric motor 4 can be configured to act as a generator when the first clutch 20 is in the first mode. When the first clutch 20 is in the first mode, the user pedaling to rotate the crank 2 will result in the rear wheel hub shell 6 rotating as a result of the pedaling. Thus, the bicycle can be used for transportation and/or training, such as out-door training. The electric motor 4 being configured to act as a generator allows for the pedaling to drive both the rear wheel hub shell 6 and the generator, i.e. for the user to feel additional resistance during pedaling, so as to provide effective training. The resistance due to the generator experienced during pedaling can be adjusted, by adjusting an electrical load resistance connected to the generator.

When the electric motor 4 is configured to act as generator, the generated electric power can be used for charging a battery of the bicycle. When the first clutch 20 is in the second mode, the generated electric power can also be used for charging a home battery, powering electrical appliances or transfer to an electricity grid.

In a third use case, the electric motor 4 is configured to act as a motor when the first clutch 20 in the first mode. When the first clutch 20 is in the first mode, the user pedaling to rotate the crank will result in the rear wheel hub shell 6 rotating as a result of the pedaling. Thus, the bicycle can be used transportation and/or training. The electric motor 4 being configured to act as a motor causes the bicycle to function as a bicycle with electric motor assistance.

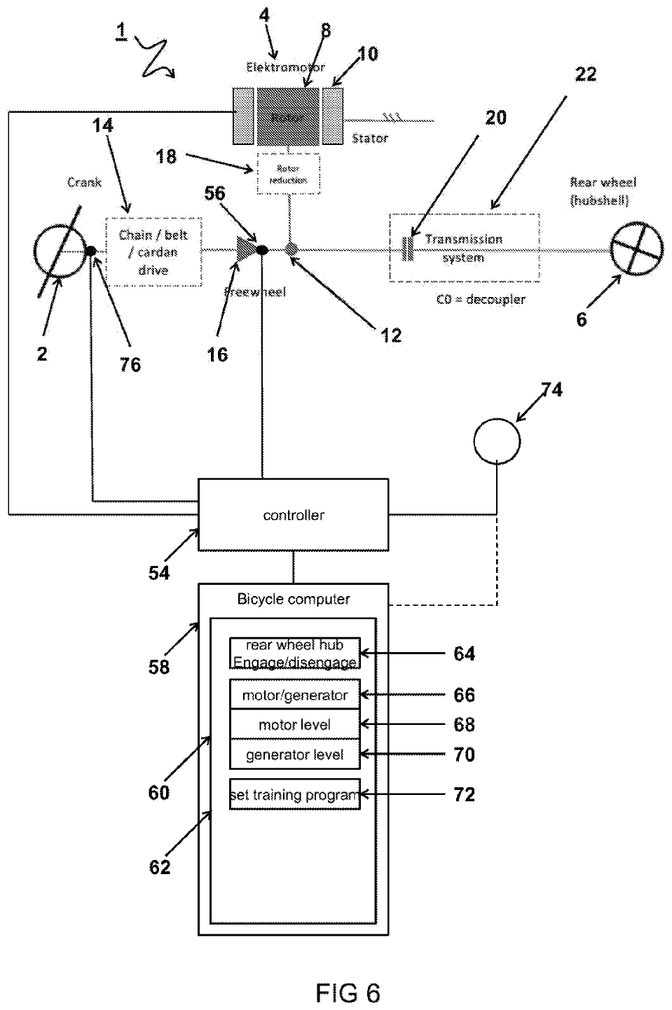

FIG. 6 shows a schematic representation of an example of a hybrid drive system 1 for a bicycle. In FIG. 6 the hybrid drive system 1 comprises a controller 54. In this example, the controller 54 is configured to control electric power provided to the electric motor 4. In this example, the controller 54 is also configured to control electric load resistance provided to the electric motor 4 acting as generator.

In this example, the system 1 comprises a torque sensor 56. between the crank and the intermediate drive part. The torque sensor 56 can combined with the first freewheel clutch 16. In this example, the torque sensor 56 is integrated in the first freewheel clutch 16. The torque sensor 56 is connected to the controller 54. In this example, the controller 54 is configured to control electric load resistance provided to the electric motor 4 acting as generator, e.g. based on the torque determined by the torque sensor 56. Here, the controller 54 can also be configured to control electric power provided to the electric motor 54, e.g. based on the torque determined by the torque sensor 56. The torque sensor 56 can be positioned inside the wheel hub shell 6, e.g. as shown in FIG. 4.

In this example the controller 54 is communicatively connected to a bicycle computer 58, e.g. via wifi, bluetooth, nfc or the like. It will be appreciated that it is also possible that the controller is part of the bicycle computer, or that the bicycle computer is part of the controller. The bicycle computer 58 includes a user interface 60. In this example, the user interface is formed by an app executed on a mobile communications device, such as a smartphone. Here, the user interface 60 is provided as a touch screen 62.

In the example of FIG. 6, the user interface 60 includes a control element 64, here an on-screen button, for switching the first clutch 20 from the first mode to the second mode, or vice versa. In this example the user interface 60 includes a control element 66, here an on-screen button, for switching the electric motor to act as motor or to act as generator. The user interface can include a control element 68 for setting a parameter representative of a value of an electric motor assistance. The user interface can include a control element 70 for setting a parameter representative of a value of an electric load resistance connected to the electric generator.

In this example, the user interface 60 includes a control element 72, here an on-screen button, for setting a training program. The training program can include a variable electric load resistance of the generator, e.g. varying in time. The training program can include a simulation of a terrain. The simulation can include a variable electric load resistance of the generator corresponding to an inclination of the simulated terrain. The user interface 60 can e.g. present a plurality of training programs and allow the user to select one. The training programs can e.g. correspond to actual existing terrains, such as “1'alpe d'Huez”, “mont Ventoux”, “col d'Aubisque”, “mergellandroute”, etc. The bicycle computer 58 can be configured to be programmed by the user to follow a predetermined load profile and to control the electric motor 4 acting as generator accordingly in riding mode (first clutch in the first mode) and in training mode (first clutch in the second mode).

When the first clutch 20 is in the second mode, the variable electric load resistance of the generator can directly correspond to an inclination of the simulated terrain. When the first clutch 20 is in the first mode, the variable electric load resistance of the generator can be calculated on the basis of a desired inclination of the simulated terrain, and on the basis of a torque exerted by the rider, e.g. as measured by the torque sensor 56. Hence, the rider can experience a training session providing resistance as if he is riding in mountainous terrain while actually riding on a level road.

In the example of FIG. 6, the system 1 includes a heart rate sensor 74 for measuring a heart rate of the rider. The heart rate sensor 74 is communicatively connected to the controller 54 and/or to the bicycle computer 58. In this example, the bicycle computer 58 is configured to adjust the electric load resistance of the generator 4 on the basis of a measured heart rate of the rider. The electric load resistance can e.g. be adjusted such that the measured heart rate of the rider corresponds to a predetermined heart rate, or follows a predetermined heart rate profile in time, such as during training.

In the example of FIG. 6, the system includes a pedaling rate sensor 76 to measure a pedaling rate of the rider. The pedaling rate sensor 76 is communicatively connected to the controller 54 and/or to the bicycle computer 58. In this example, the bicycle computer 58 is configured to adjust an electric load resistance of the generator 4, an electric power provided to the electric motor 4, and/or a transmission ratio of one or more of the first 14, second 18, third 22 and fourth 24 transmissions, on the basis of a measured pedaling rate of the rider. The electric load resistance of the generator, electric power provided to the electric motor, and/or transmission ratio of one or more of the first, second, third and fourth transmissions can e.g. be adjusted such that the measured pedaling rate of the rider corresponds to a predetermined pedaling rate, or follows a predetermined pedaling rate profile in time, such as during training. One or more of the first, second, third and fourth transmissions can be a continuously variable transmission. The bicycle computer 58 can be configured to adjust the transmission ratio of the continuously variable transmission such that the measured pedaling rate of the rider corresponds to a predetermined pedaling rate, or follows a predetermined pedaling rate profile in time, such as during training.

The system 1 can be configured to determine a pedaling power of the rider. The pedaling power can e.g. be determined based on the torque sensor 56. Alternatively, or additionally, the system 1 can include a pedaling power sensor. In this example, the bicycle computer 58 is configured to adjust an electric load resistance of the generator 4, an electric power provided to the electric motor 4, and/or a transmission ratio of one or more of the first 14, second 18, third 22 and fourth 24 transmissions, on the basis of a determined pedaling power of the rider. The electric load resistance of the generator, electric power provided to the electric motor, and/or transmission ratio of one or more of the first, second, third and fourth transmissions can e.g. be adjusted such that the measured pedaling power of the rider corresponds to a predetermined pedaling power, or follows a predetermined pedaling power profile in time, such as during training.

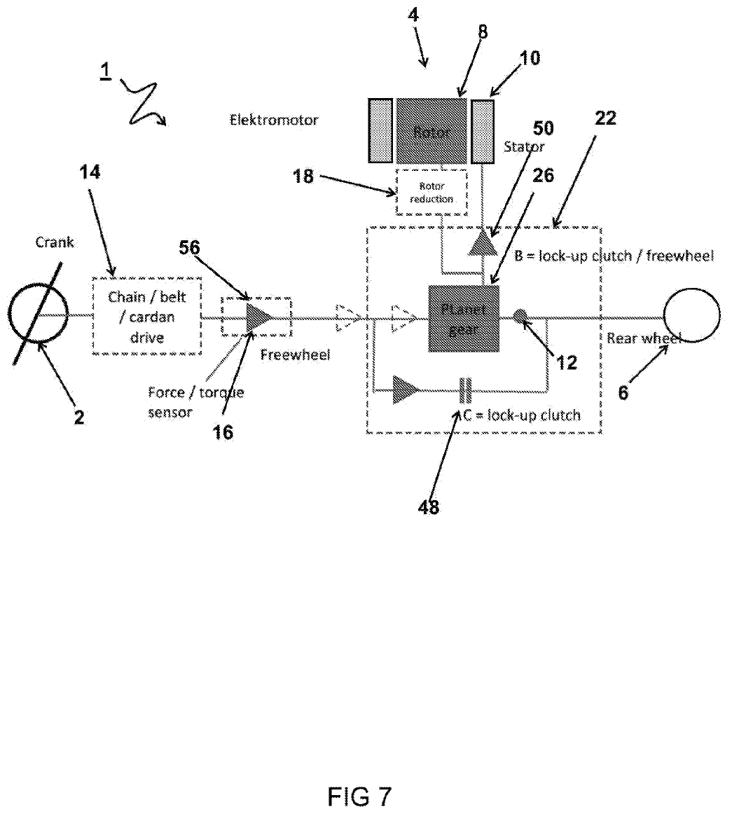

FIG. 7 shows a schematic representation of an example of a hybrid drive system 1 for a bicycle. The system 1 of FIG. 7 is similar to the system 1 of FIG. 3. The differences, and some of the similarities with respect to FIG. 3, will be discussed below.

In this example, the intermediate drive part 12 drives the hub shell 6 directly. For example the intermediate drive part 12 is rigidly connected or connectable to the hub shell 6. Similar to the hybrid drive system 1 of FIG. 3, the third transmission 22 comprises a planetary gear set 26. The planetary gear set includes at least three rotational members. The at least three rotational members here include a sun gear 26S, a planet carrier 26C with one or more planet gears 26P and a ring gear 26R. The third transmission further includes a second clutch 48 and a second freewheel clutch 50. Here, the intermediate drive part 12 is rigidly connected to the planet carrier 26C. In particular, the intermediate drive part 12 is formed by the planet carrier 26C. The planet carrier 26C of the third transmission 22 is, here, rigidly connected to the hub shell 6, but the planet carrier 26C can also be connected or connectable to the hub shell 6 via e.g. a spline or clutch. The sun gear 26S of the third transmission 22 is connected to the axle 36 similarly as explained in respect of the previous Figures, e.g. in respect of FIG. 3.

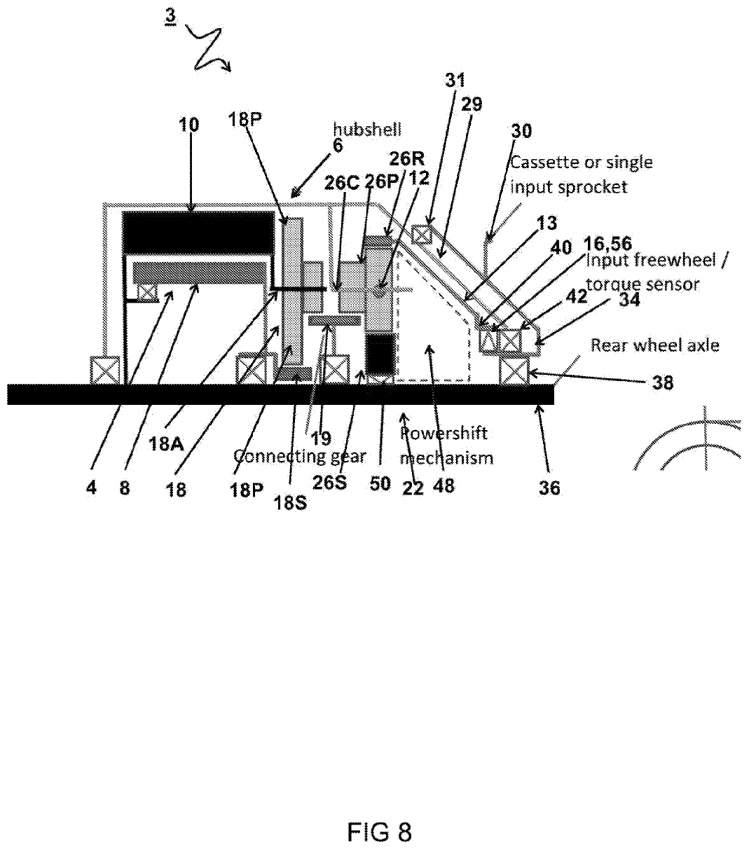

FIG. 8 shows a schematic representation of an example of a cross sectional view of a wheel hub assembly 3. The wheel hub assembly 3 can be part of the hybrid drive system 1, in particular of the hybrid system 1 as shown in FIG. 7. The wheel hub assembly of FIG. 8 shows similarities to the wheel hub assembly of FIG. 4. The differences, and some of the similarities, will be discussed below. FIG. 8 shows a single sprocket 30. It will be appreciated that instead of single sprocket 30 it is also possible that a cassette 28 is attached to the driver 34, or a plurality of sprockets, or a belt pulley, or a (bevel gear). What is explained in view of the cassette 28 in view of FIG. 4, especially in view of the central opening 29 and its relation to the intermediate drive part 12 and the wheel hub shell 6, applies similarly to FIG. 8, also in view of the single sprocket, the plurality of sprockets, the belt pulley or the (bevel) gear.

In FIG. 8 the driver 34 drives an intermediate shell 13 in rotation via a first freewheel clutch 16. The intermediate shell 13 drives the hub shell 6 via the third transmission 22. In this example, the first clutch 20 is omitted, although it may of course be included. The third transmission 22 in this example includes a planetary gear set 26. Here, the intermediate shell 13 is rigidly connected to the ring gear 26R. The planet carrier 26C is rigidly connected to the hub shell 6. It is possible that the planet carrier 26C is rigidly connected to an input of the first clutch 20 and the output of the first clutch 20 is rigidly connected to the hub shell 6. In this example, the planet carrier 26C forms the intermediate drive part 12. The sun gear 26S is connected to the axle 36 as explained below. In this example, the third transmission 22 includes two selectable transmission ratios. For switching between the two ratios the third transmission 22 includes a second clutch 48. In a first mode, the second clutch 48 rotationally couples the planet carrier 26C to corotate with the ring gear 26R. Hence, a unity transmission ratio is provided. The sun gear 26S is allowed to rotate in a forward drive direction relative to the axle 36 because of a second freewheel clutch 50 between the sun gear 26S and the axle 36. In a second mode, the second clutch 48 decouples the planet carrier 26C from the ring gear 26R. Hence, the planet carrier 26C can rotate independently from the ring gear 26R. The second freewheel clutch 50 prevents the sun gear 26S from rotating in a rearward drive direction relative to the axle 36. Hence, a reducing transmission ratio is provided.

FIG. 8 further shows the electric motor 4. In this example the rotor 8 is positioned concentrically inside the stator 10 of the electric motor 4. The stator 10 is rigidly connected to the axle 36. The axle 36 is configured to be attached to a frame of the bicycle, such that the axle 36 does not rotate relative to the frame. The rotor 8 is connected to the intermediate drive part 12 via the second transmission 18. Here, the rotor 8 drives a sun gear 18S. The sun gear 18S drives a planet gear 18P which rotates around an axis 18A rigidly connected to the axle 36. In this example, the planet gear 18P is a stacked gear of two sizes. The planet gear 18P meshes with a connecting gear 19 that also meshes with the planet gear 26P of the third transmission 22.

It will be appreciated that the hub shell 6 can include spokes flanges 52 for connecting spokes of a bicycle wheel thereto.

In the example of FIG. 8, the electric motor 4, the intermediate drive part 12, and the second transmission 18 are positioned inside the rear wheel hub shell 6. Further, in the example of FIG. 8, the first freewheel clutch 16 is also positioned inside the rear wheel hub shell 6. In the example of FIG. 8, further the third transmission 22, the second clutch 48 and the second freewheel clutch 50 are positioned inside the rear wheel hub shell 6.

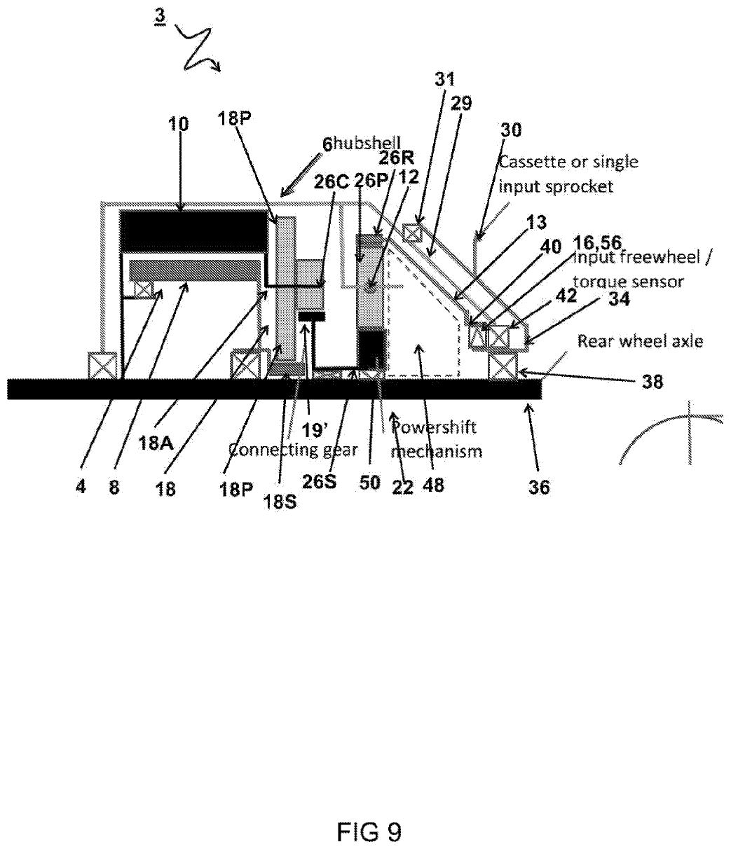

FIG. 9 shows a schematic representation of an example of a cross sectional view of a wheel hub assembly 3. The wheel hub assembly 3 can be part of the hybrid drive system 1, in particular of the hybrid drive system 1 as shown in FIG. 7. The wheel hub assembly of FIG. 9 shows similarities to the wheel hub assembly of FIG. 8, and hence also to the wheel hub assembly of FIG. 4. The differences, and some of the similarities, with respect to the wheel hub assembly as shown in FIG. 8 will be discussed below.

In FIG. 9, the sun gear 26S of the third transmission 22 meshes with the planet gear 18P of the second transmission 18. Here, the sun gear 26S is a stacked gear of two sizes. In analogy to the wheel hub assembly of FIG. 8, the wheel hub assembly of FIG. 9 can be viewed as having the intermediate gear 19′ rigidly fixed to, e.g. integrally formed with, the sun gear 26S of the third transmission 22.

Herein, the invention is described with reference to specific examples of embodiments of the invention. It will, however, be evident that various modifications, variations, alternatives and changes may be made therein, without departing from the essence of the invention.

The system of FIG. 2B comprises a fourth transmission 24. It will be appreciated that that the fourth transmission 24 can replace, or be used in addition to, the third transmission in the examples of FIGS. 2A, 3, 4, 5B and 6.

It will be clear that the third transmission 22 in the examples of FIGS. 2A, 3, 4, 5A, 5B and 6 may be omitted. The third transmission 22 can e.g. be replaced by a direct connection or a transmission having unity transmission ratio.

It will be appreciated that in the examples the first transmission 14 and/or the second transmission 18 may be omitted. The first and/or second transmission can e.g. be replaced by a direct connection or a transmission having unity transmission ratio.

In the example of FIGS. 1, 2A, 2B, 3, 6 and 7, the electric motor 4 can positioned at the rear wheel or at the crank. The electric motor 4 can e.g. be integrated in the rear wheel hub shell 6. The electric motor 4 can e.g. be mounted to or integrated in a crank axle assembly.

However, other modifications may be envisaged.

For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A hybrid drive system for a bicycle comprising:
a crank;
an electric motor;
a rear wheel hub shell;
an intermediate drive part;
a first connection connecting the crank to the intermediate drive part; and
a second connection connecting the electric motor to the intermediate drive part;
wherein the intermediate drive part is connected or connectable to the rear wheel hub shell.

2. The hybrid drive system of claim 1, comprising a first clutch between the intermediate drive part and the rear wheel hub shell for in a first mode rotationally coupling the rear wheel hub shell to the intermediate drive part, and in a second mode rotationally decoupling the rear wheel hub shell from the intermediate drive part in at least one rotation direction.

3. The hybrid drive system of claim 2, wherein the first clutch is arranged for in the second mode rotationally decoupling the rear wheel hub shell from the intermediate drive part in at least the forward drive rotation direction.

4. The hybrid drive system of claim 2 or 3, wherein the first clutch is arranged for in the second mode rotationally decoupling the rear wheel hub shell from the intermediate drive part, such that there is no component that is driving the hub shell from the crank and/or the electric motor.

5. The hybrid drive system of any of claims 2-4, wherein the first clutch is a form-closed clutch.

6. The hybrid drive system of any of claims 2-5, wherein the first clutch is an active form-closed clutch.

7. The hybrid drive system of any of claims 2-4, wherein the first clutch is an active freewheel clutch configured to be actively disengaged.

8. The hybrid drive system of claim 7, wherein the first clutch configured to be actively disengaged by an electric actuator.

9. The hybrid drive system of any of claims 1-8, wherein the electric motor is configured to act as a generator when the first clutch is in the second mode.

10. The hybrid drive system of claim 9, wherein the electric motor is configured to act as a generator for power coming from the crank.

11. The hybrid drive system of any of claims 1-10, wherein the electric motor is configured to act as a generator when the first clutch is in the first mode.

12. The hybrid drive system of claim 11, wherein the electric motor is configured to act as a generator for power coming from the crank and/or the wheel.

13. The hybrid drive system of any of claims 1-12, wherein the electric motor is configured to act as a motor for driving the wheel when the first clutch in the first mode.

14. The hybrid drive system of any of claims 1-13, comprising a manual or electric activator for switching the first clutch from the first mode to the second mode, or vice versa.

15. The hybrid drive system of any of claims 1-14, comprising a first freewheel clutch between the crank to the intermediate drive part, having an input and an output, and configured to automatically engage when the speed of the input is higher than the speed of the output in a forward movement direction, and to disengages when the speed of the input is lower than the speed of the output in forward direction.

16. The hybrid drive system of any of claim 2 or 3-14 as far as dependent from claim 2, comprising a first freewheel clutch between the intermediate drive part and the first clutch, having an input and an output, and configured to automatically engage when the speed of the input is higher than the speed of the output in a forward movement direction, and to disengages when the speed of the input is lower than the speed of the output in forward direction.

17. The hybrid drive system of any of claim 2 or 3-14 as far as dependent from claim 2, comprising a first freewheel clutch between the first clutch and the rear wheel hub shell, having an input and an output, and configured to automatically engage when the speed of the input is higher than the speed of the output in a forward movement direction, and to disengages when the speed of the input is lower than the speed of the output in forward direction.

18. The hybrid drive system of any of claims 1-17, wherein the electric motor is positioned near the crank.

19. The hybrid drive system of any of claims 1-18, wherein the rotor of the electric motor is concentric with the crank shaft.

20. The hybrid drive system of any of claims 1-17, wherein the electric motor is positioned at the rear wheel hub shell.

21. The hybrid drive system of any of claim 1-17 or 20, wherein the rotor of the electric motor is concentric with the rear wheel hub shell.

22. The hybrid drive system of any of claims 1-21, wherein the first connection is a first transmission.

23. The hybrid drive system of any of claims 1-22, wherein the second connection is a second transmission.

24. The hybrid drive system of any of claims 1-23, comprising a third transmission between the intermediate drive part and the rear wheel hub shell.

25. The hybrid drive system of any of claims 1-24, comprising a fourth transmission between the crank and the intermediate drive part.

26. The hybrid drive system of claim 24 or 25, wherein the third and/or fourth transmission has at least two selectable transmission ratios.

27. The hybrid drive system of claim 26, where the third and/or fourth transmission is configured to shift between the at least two transmission ratios under load.

28. The hybrid drive system of any of claims 20-27, wherein the first clutch is part of the third transmission.

29. The hybrid drive system of any of claims 1-28, comprising a torque sensor between the crank and the intermediate drive part.

30. The hybrid drive system of claims 15 and 29, wherein the torque sensor is combined with the first freewheel clutch.

31. The hybrid drive system of claims 15 and 29, wherein the torque sensor is combined with the first or the fourth transmission.

32. The hybrid drive system of any of claims 1-31, wherein the second and/or third and/or fourth transmission comprises a planetary gear set with at least three rotational members.

33. The hybrid drive system of claim 32, comprising a second clutch configured for selectively connecting two of the at least three rotational members.

34. The hybrid drive system claim 33, comprising a second freewheel clutch between one of the rotational members and the second clutch.

35. The hybrid drive system of any of claims 32-34, comprising a third freewheel clutch between one of the rotation members and a stator of the electric motor.

36. The hybrid drive system of claim 35, wherein the third freewheel clutch includes the first clutch.

37. The hybrid drive system of any of the preceding claims, wherein the second transmission includes a reduction gearing between a rotor of the electric motor and the intermediate drive part.

38. The hybrid drive system of any of the preceding claims, wherein the intermediate drive part is formed by, or rigidly connected to, a planet carrier of a planetary gear set of the second and/or third and/or fourth transmission.

39. The hybrid drive system of claim 38, wherein the crank is connected to the intermediate drive part via a ring gear of the planetary gear set of the second and/or third and/or fourth transmission.

40. The hybrid drive system of claim 38 or 39, wherein the electric motor is connected to the intermediate drive part via a sun gear of the planetary gear set of the second and/or third and/or fourth transmission.

41. The hybrid drive system of claim 40, wherein a rotor or stator of the electric motor is connected to the sun gear of the planetary gear set of the second and/or third and/or fourth transmission via a clutch, preferably a one-way clutch.

42. The hybrid drive system of any of the preceding claims, comprising a controller configured to control electric power provided to the electric motor and/or configured to control electric load resistance provided to the electric motor acting as generator.

43. The hybrid drive system of claim 42, wherein the controller is arranged to track a predetermined reference rotational speed of the crank and/or a predetermined reference ratio between the power output of the electric motor and the power output of the rider.

44. The hybrid drive system of claim 42 or 43, comprising a speed sensor configured for measuring a speed of the bicycle and/or a rotational speed of a wheel of the bicycle, the controller being operatively connected to the speed sensor.

45. The hybrid drive system of any of claims 42-44, wherein the controller includes or is communicatively connectable to bicycle computer.

46. The hybrid drive system of claim 45, wherein the bicycle computer can include a user interface including an input, such as a touch screen and/or buttons, and an output, such as a screen.

47. The hybrid drive system of claim 45 or 46, wherein the user interface is configured for allowing a user to select operation of the first clutch.

48. The hybrid drive system of claim 45, 46 or 47, wherein the user interface is configured for allowing the user to control operation of the electric motor.

49. The hybrid drive system of claim 48, wherein the user interface includes a control element for switching the electric motor to act as motor or to act as generator.

50. The hybrid drive system of claim 48 or 49, wherein the user interface includes a control element for setting a parameter representative of a value of an electric load resistance connected to the electric generator.

51. The hybrid drive systems of any of claims 42-50, wherein the bicycle computer is configured to be programmed by the user to follow a certain load profile and to control the electric motor accordingly.

52. The hybrid drive system of any of the preceding claims, comprising a heart rate sensor to measure a heart rate of the rider.

53. The hybrid drive system of claim 52 and any of claims 45-51, wherein the bicycle computer is configured to adjust the electric load resistance of the generator on the basis of a measured heart rate of the rider, for instance such that the measured heart rate of the rider corresponds to a predetermined heart rate, or follows a predetermined heart rate profile in time.

54. The hybrid drive system of any of the preceding claims, comprising a pedaling rate sensor to measure a pedaling rate of the rider.

55. The hybrid drive system of claim 54, and any of claim 45-51 or 53, wherein the bicycle computer is configured to adjust an electric load resistance of the generator, an electric power provided to the electric motor, and/or a transmission ratio of one or more of the first, second, third and fourth transmissions, on the basis of a measured pedaling rate of the rider, for instance such that the measured pedaling rate of the rider corresponds to a predetermined pedaling rate, or follows a predetermined pedaling rate profile in time.

56. The hybrid drive system of any of the preceding claims, wherein one or more of the first, second, third and fourth transmissions is a continuously variable transmission.

57. The hybrid drive system of claim 56 and any of claims 45-51, 53 or wherein the bicycle computer is configured to adjust the continuously variable transmission such that the measured pedaling rate of the rider corresponds to a predetermined pedaling rate, or follows a predetermined pedaling rate profile in time.

58. The hybrid drive system of any of the preceding claims, configured to determine a pedaling power of the rider.

59. The hybrid drive system of claim 58 and any of claim 45-51, 53, 55 or 57, wherein the bicycle computer is configured to adjust an electric load resistance of the generator, an electric power provided to the electric motor, and/or a transmission ratio of one or more of the first, second, third and fourth transmissions, on the basis of a determined pedaling power of the rider, for instance such that the measured pedaling power of the rider corresponds to a predetermined pedaling power, or follows a predetermined pedaling power profile in time.

60. The hybrid drive system of any of the preceding claims, wherein the electric motor, the intermediate drive part, the first clutch and the second transmission are positioned inside the rear wheel hub shell.

61. The hybrid drive system of claim 60, wherein one or more of the first freewheel clutch, the third transmission and the fourth transmission are positioned inside the rear wheel hub shell.

62. A rear wheel hub assembly for a bicycle, comprising:
a driver connectable to a crank of the bicycle;
an electric motor;
an intermediate drive part rotationally coupled to the driver and rotationally coupled to a rotor of the electric motor; and
a rear wheel hub shell;
wherein the intermediate drive part is connected or connectable to the rear wheel hub shell.

63. The rear wheel hub assembly of claim 62, including a second transmission, wherein the intermediate drive part is rotationally coupled to the rotor of the electric motor via the second transmission.

64. The rear wheel hub assembly of claim 62 or 63, wherein the rotor of the electric motor is concentric with the rear wheel hub shell.

65. The rear wheel hub assembly of claim 62, 63 or 64, comprising a first clutch between the intermediate drive part and the rear wheel hub shell for in a first mode rotationally coupling the rear wheel hub shell to the intermediate drive part, and in a second mode rotationally decoupling the rear wheel hub shell from the intermediate drive part in at least one rotation direction.

66. The rear wheel hub assembly of claim 65, wherein the first clutch is a form-closed clutch.

67. The rear wheel hub assembly of claim 65 or 66, wherein the first clutch is an active form-closed clutch.

68. The rear wheel hub assembly of claim 65, wherein the first clutch is an active freewheel clutch configured to be actively disengaged.

69. The rear wheel hub assembly of any of claims 62-68, comprising an axle, such as a hollow axle, around which the hub shell revolves, wherein a stator of the electric motor is rigidly connected to the axle.

70. The rear wheel hub assembly of any of claims 62-69, wherein the wheel hub shell and/or the intermediate drive part is positioned, at least partially, radially inside a sprocket, a plurality of sprockets, a cassette, a belt pulley or a gear connected to the driver.

71. The rear wheel hub assembly of claim 70, wherein the sprocket, the plurality of sprockets, the cassette, the belt pulley or the gear has a tapered central axial opening having an internal diameter decreasing in a direction away from a center of the rear wheel hub assembly.

72. The rear wheel hub assembly of claim 70 or 71, wherein the sprocket, the plurality of sprockets, the cassette, the belt pulley or the gear and the driver are configured to transmit torque from the sprocket, the plurality of sprockets, the cassette, the belt pulley or the gear to the driver at portion of the sprocket, the plurality of sprockets, the cassette, the belt pulley or the gear axially away from the center of the wheel hub assembly.

73. The rear wheel hub assembly of any of claims 62-72, wherein the driver is configured to transmit torque to the intermediate drive part on a diameter smaller than that of a smallest sprocket connected to the driver.

74. The rear wheel hub assembly of any of claims 62-73, wherein sprocket(s), a cassette, a belt pulley or gear which are connected to the driver are supported directly via a bearing on the wheel hub shell.

75. The rear wheel hub assembly of any of claims 62-74, wherein the wheel hub shell is supported on the driver side of the wheel hub assembly via a bearing, which bearing is positioned axially further from a center of the wheel hub assembly than the axial position of the a middle sprocket.

76. The rear wheel hub assembly of any of claims 62-75, wherein the rear wheel hub shell is configured to be decoupled from the driver.

77. A crank axle assembly for a bicycle, comprising:
a crank shaft;
an electric motor;
an intermediate drive part rotationally coupled to the crank shaft and rotationally coupled to a rotor of the electric motor;
wherein the intermediate drive part is connected or connectable to a rear wheel hub shell.

78. The crank axle assembly of claim 77, wherein the rotor of the electric motor is concentric with the crank shaft.

79. The crank axle assembly of claim 77 or 78, including a second transmission, wherein the intermediate drive part is rotationally coupled to the rotor of the electric motor via the second transmission.

80. The crank axle assembly of claim 77, 78 or 79, comprising a first clutch between the intermediate drive part and the rear wheel hub shell for in a first mode rotationally coupling the rear wheel hub shell to the intermediate drive part, and in a second mode rotationally decoupling the rear wheel hub shell from the intermediate drive part in at least one rotation direction.

81. The crank axle assembly of claim 80, wherein the first clutch is a form-closed clutch.

82. The crank axle assembly of claim 80 or 81, wherein the first clutch is an active form-closed clutch.

83. The crank axle assembly of claim 80, wherein the first clutch is an active freewheel clutch configured to be actively disengaged.

84. A bicycle rear wheel including the hybrid drive system of any of claims 1-61, or the rear wheel hub assembly of any of claims 62-76.

85. A bicycle including the rear wheel of claim 84.

86. A bicycle including the crank axle assembly according to any of claims 77-83.
